(19) United States
(12) Patent Application Publication
(10) Pub. No.: US 2025/0303914 A1
(43) Pub. Date: Oct. 2, 2025

(54) BATTERY SWAP APPARATUS

(71) Applicant: TOYOTA JIDOSHA KABUSHIKI KAISHA, Toyota-shi (JP)

(72) Inventors: Tsubasa MIGITA, Sakai-shi (JP); Taro MATSUSHITA, Toyokawa-shi (JP); Yasuhiro KURODA, Toyota-shi (JP); Akio UOTANI, Nagoya-shi (JP); Shinji ICHIKAWA, Nagoya-shi (JP); Shuta ITO, Toyota-shi (JP)

(73) Assignee: TOYOTA JIDOSHA KABUSHIKI KAISHA, Toyota-shi (JP)

(21) Appl. No.: 18/985,687

(22) Filed: Dec. 18, 2024

(30) Foreign Application Priority Data
Mar. 27, 2024 (JP) 2024-051963

(51) Int. Cl. B60L 53/80; G06T 7/00; H01M 10/48

(52) U.S. Cl. CPC B60L 53/80; G06T 7/001; H01M 10/48; B60L 2250/00; H01M 2220/20

(57) ABSTRACT

The battery swap apparatus includes a battery swap processing unit that executes a battery swap process for swapping a battery pack (battery) mounted on an electrified vehicle, and an inspection unit that inspects a status of a battery swap portion of electrified vehicle prior to the battery swap process. The position (first position) at which the battery swap process is executed by the battery swap processing unit is different from the position (second position) at which the inspection is executed by the inspection unit.

### CROSS-REFERENCE TO RELATED APPLICATION

This application claims priority to Japanese Patent Application No. 2024-051963 filed on Mar. 27, 2024, incorporated herein by reference in its entirety.

### BACKGROUND

### 1. Technical Field

The present disclosure relates to battery swap apparatuses.

### 2. Description of Related Art

Japanese Unexamined Patent Application Publication No. 2012-008020 (JP 2012-008020 A) discloses a vehicle whose battery is swapped out by a battery swap apparatus. A navigation device of the vehicle displays an image showing a battery swap position and a position where the battery is mounted on the vehicle, based on an image of the battery swap position captured by a camera mounted on the vehicle.

### SUMMARY

Although not specified in JP 2012-008020 A, it is conceivable to detect an abnormality in the vehicle (abnormality in a portion related to battery swapping) based on an image captured by the camera. Therefore, a predetermined time is required for each of battery swapping and inspection, so that a traffic congestion may occur due to a vehicle waiting in front of the battery swap apparatus (battery replacement apparatus) for battery swapping.

The present disclosure was made to solve the above issue, and an object thereof is to provide a battery swap apparatus that can reduce a traffic congestion due to an electrified vehicle waiting for a battery swap process.

A battery swap apparatus according to an aspect of the present disclosure is a battery swap apparatus that executes a battery swap process for swapping out a battery mounted on an electrified vehicle. The battery swap apparatus includes:
a battery swap processing unit configured to execute the battery swap process; and an inspection unit configured to inspect a state of a battery swap portion of the electrified vehicle before the battery swap process. The battery swap portion is a portion related to the battery swap process.

A first position where the battery swap process is executed by the battery swap processing unit is different from a second position where inspection is executed by the inspection unit.

In the battery swap apparatus according to the aspect of the present disclosure, as described above, the inspection that is executed before the battery swap process is executed at the second position different from the first position where the battery swap process is executed. Whether there is an abnormality in the battery swap portion can therefore be determined by the inspection before the electrified vehicle is moved to the first position. It is therefore possible to prompt a user of the electrified vehicle that has the abnormality in the battery swap portion to remove the electrified vehicle from the battery swap apparatus. The above configuration can thus reduce the possibility that the electrified vehicle having the abnormality may be moved to the first position. As a result, it is possible to reduce a traffic congestion due to the electrified vehicle waiting for the battery swap process, compared to the case where all electrified vehicles are moved to the first position.

The battery swap apparatus may further include: a swappability determination unit configured to determine whether the battery swap process is executable, based on a result of the inspection by the inspection unit; and
a notification unit configured to execute a notification process for notifying the user of the electrified vehicle of information.

When the swappability determination unit determines that the battery swap process is not executable, the notification unit may execute the notification process for notifying the user that the battery swap process is not executable, before the electrified vehicle is moved to the first position.

This configuration can easily reduce the possibility that the electrified vehicle whose battery is not swappable may be moved to the first position, by notifying the user that the battery swap process is not executable. As a result, it is possible to easily reduce a traffic congestion due to the electrified vehicle waiting for the battery swap process.

The battery swap apparatus may further include:
an abnormality determination unit configured to determine whether there is an abnormality in the battery swap portion, based on a result of the inspection by the inspection unit; and
an abnormality elimination unit configured to execute an abnormality elimination process for eliminating the abnormality in the battery swap portion.

The abnormality elimination unit may execute the abnormality elimination process when the abnormality determination unit determines that there is the abnormality in the battery swap portion.

With this configuration, the battery swap process can be executed even on the electrified vehicle determined to have an abnormality by the abnormality determination unit, when the abnormality is eliminated by the abnormality elimination unit.

The inspection unit may inspect the electrified vehicle at the second position while the battery swap process is being executed on another electrified vehicle at the first position.

This configuration allows the battery swap process at the first position and the inspection at the second position to be executed in parallel. As a result, the time required to execute the inspection and the battery swap process on a plurality of electrified vehicles can be reduced compared to the case where the battery swap process and the inspection are executed at different timings. This can further reduce a traffic congestion due to the electrified vehicle waiting for the battery swap process.

The inspection unit may include at least one of the following: an imaging unit configured to capture an image of the battery swap portion, a jig that is accessible to the battery swap portion, and an acquisition unit configured to acquire information that is based on a tilt of the battery swap portion.

This configuration makes it easier to inspect the state of the battery swap portion using at least one of the above components: the imaging unit, the jig, and the acquisition unit.

The present disclosure can reduce a traffic congestion due to the electrified vehicle waiting for the battery swap process.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a configuration of a battery swap system according to an embodiment;

FIG. 2 is a diagram illustrating a camera of an inspection unit according to an embodiment;

FIG. 3 is a diagram illustrating a lift-up apparatus for an inspection unit according to an embodiment;

FIG. 4 is a diagram illustrating an inspection jig of an inspection unit according to an embodiment;

FIG. 5 is a view illustrating a cleaning unit (water discharge unit) of an inspection unit according to an embodiment; and

FIG. 6 is a sequence diagram illustrating control by a battery swap system according to an embodiment.

### DETAILED DESCRIPTION OF EMBODIMENTS

Hereinafter, an embodiment of the present disclosure will be described in detail with reference to the drawings. The same or corresponding parts in the drawings are designated by the same reference characters and repetitive description will be omitted.

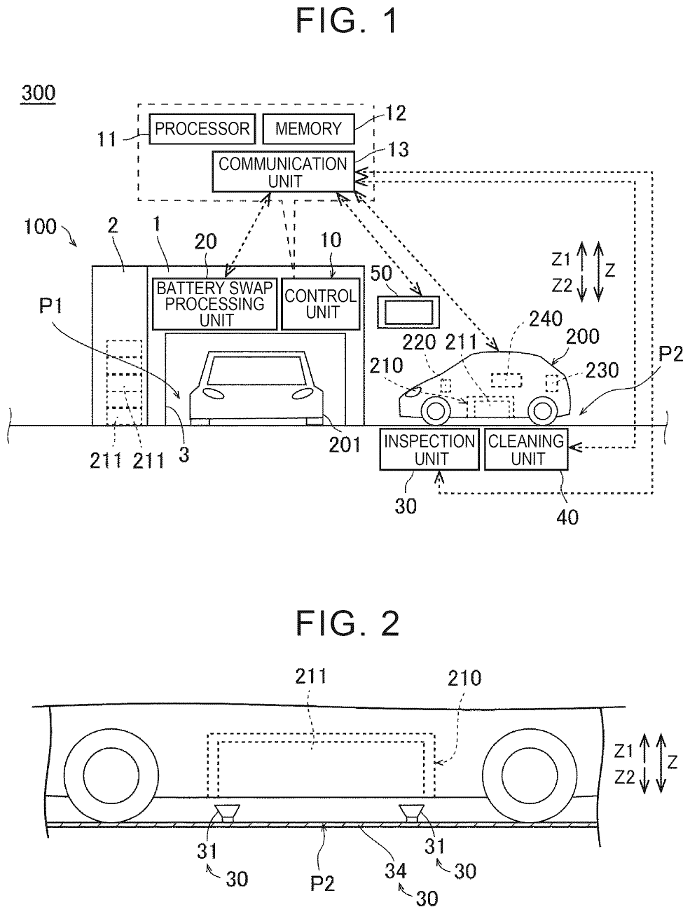

FIG. 1 is a diagram illustrating a battery swap system 300 according to the present embodiment. The battery swap system 300 includes a battery swap apparatus 100 and an electrified vehicle 200. In this specification, the Z direction is the up-down direction, and Z1 direction and Z2 direction are the up-down direction and the down-down direction, respectively.

Electrified vehicle 200 is, for example, Plug-in Hybrid Electric Vehicle (PHEV), Battery Electric Vehicle (BEV), or Fuel Cell Electric Vehicle (FCEV).

Electrified vehicle 200 includes a battery-pack 211, a navigational device 220, a communication device 230, and a heater 240. The battery pack 211 is mounted in the electrified vehicle 200 in such a manner that the battery pack 211 is swappable. In electrified vehicle 200, the battery pack 211 is swapped out in the battery swap apparatus 100. Accordingly, the battery pack 211 provided in the battery swap apparatus 100 is attached to electrified vehicle 200. The battery pack 211 is an example of a “battery” of the present disclosure.

The battery pack 211 stores electric power used for driving (for example, traveling) electrified vehicle 200. The battery pack 211 is provided in the battery swap portion 210 of the electrified vehicle 200. The battery swap portion 210 is a portion of electrified vehicle 200 that is related to the battery swap process. For example, in addition to the battery pack 211, the battery swap portion 210 is provided with a fastening member for fixing (fastening) the battery pack 211 to the vehicle body of electrified vehicle 200, and a fixing member for fixing the battery pack 211. The fastening member is, for example, a bolt 212 (FIG. 4) or the like. The fixing member is a rocker (not shown) or the like.

The battery cell provided in the battery pack 211 is constituted by a secondary battery such as a lithium-ion battery, a nickel metal hydride battery, or a sodium-ion battery. The type of the secondary battery may be a liquid secondary battery or an all-solid secondary battery. A plurality of secondary batteries may form a battery pack.

The communication device 230 communicates with a communication unit 13, which will be described later, of the battery swap apparatus 100, an external server, or the like. The heater 240 is provided to raise the temperature of the battery pack 211 (battery swap portion 210). The heater 240 may be a dedicated heater provided to raise the temperature of the battery swap portion 210.

The battery swap apparatus 100 includes a battery swap apparatus body 1 and a storage 2. A battery pack 211 is stored in the storage 2. The battery swap apparatus body 1 is provided in the storage 2.

In the battery swap apparatus body 1, the battery swap process is executed on the electrified vehicle 200. The battery swap apparatus body 1 is an apparatus that performs battery swapping for swapping out the battery pack 211 mounted in the electrified vehicle 200 with the battery pack 211 provided in the storage 2. The battery swap apparatus 100 (battery swap apparatus body 1) is provided with an entrance 3 for electrified vehicle 200 to and from.

The battery swap process is executed in the position P1 inside the battery swap apparatus body 1. In other words, the battery swap process is executed with electrified vehicle 200 disposed in the position P1. Note that the position P1 is an example of the “first position” of the present disclosure.

The battery swap apparatus 100 includes a control unit 10, a battery swap processing unit 20, an inspection unit 30, a cleaning unit 40, and a display unit 50. The control unit 10 controls, for example, each of the battery swap processing unit 20, the inspection unit 30, the cleaning unit 40, and the display unit 50. Note that the control unit 10 may be provided at a location different from that of the battery swap apparatus body 1. The processor 11 is an example of the “swappability determination unit” and the “abnormality determination unit” of the present disclosure.

The control unit 10 includes a processor 11, a memory 12, and a communication unit 13. In the memory 12, information (for example, a map, a mathematical expression, and various parameters) used in the program is stored in addition to the program executed by the processor 11. The communication unit 13 is an example of a “notification unit” of the present disclosure.

The battery swap processing unit 20 executes processing of exchanging the battery pack 211 mounted on electrified vehicle 200 and the battery pack 211 stored in the storage 2.

The inspection unit 30 inspects the state of the battery swap portion 210. The inspection unit 30 inspects the state of the battery swap portion 210 before the battery swap process is executed. The inspection unit 30 is provided in the position P2 of the battery swap apparatus 100. The position P2 is a position that differs from the position P1 in which the battery swap process is executed. The position P2 is external to the battery swap apparatus body 1. Electrified vehicle 200 moves to the position P1 after being inspected by the inspection unit 30 in the position P2, and undergoes a battery swap process in the position P1. Details of the inspection unit 30 will be described later. Note that the position P2 is an example of the “second position” of the present disclosure. In addition, the battery swap apparatus 100 may include a conveyor (for example, a belt conveyor or the like) that conveys electrified vehicle 200 from the position P2 to the position P1.

The inspection unit 30 is driven independently of the battery swap processing unit 20. Thus, the inspection unit 30 can inspect the electrified vehicle 200 at the position P1 while the battery swap process is being executed on another electrified vehicle 201 at the position P1 by the battery swap processing unit 20. In other words, the battery swap apparatus 100 allows the inspection unit 30 to execute the inspection process while the battery swap process is executed by the battery swap processing unit 20.

The cleaning unit 40 is, for example, a device that cleans the battery swap portion 210. The cleaning unit 40 is provided in the position P2 in the same manner as the inspection unit 30. Details of the cleaning unit 40 will be described later.

The display unit 50 is provided at a position visible to a user riding on an electrified vehicle 200 arranged in the position P2.

Each of the battery swap processing unit 20, the inspection unit 30, the cleaning unit 40, and the display unit 50 is driven (operated) based on a command signal transmitted from the processor 11 through the communication unit 13.

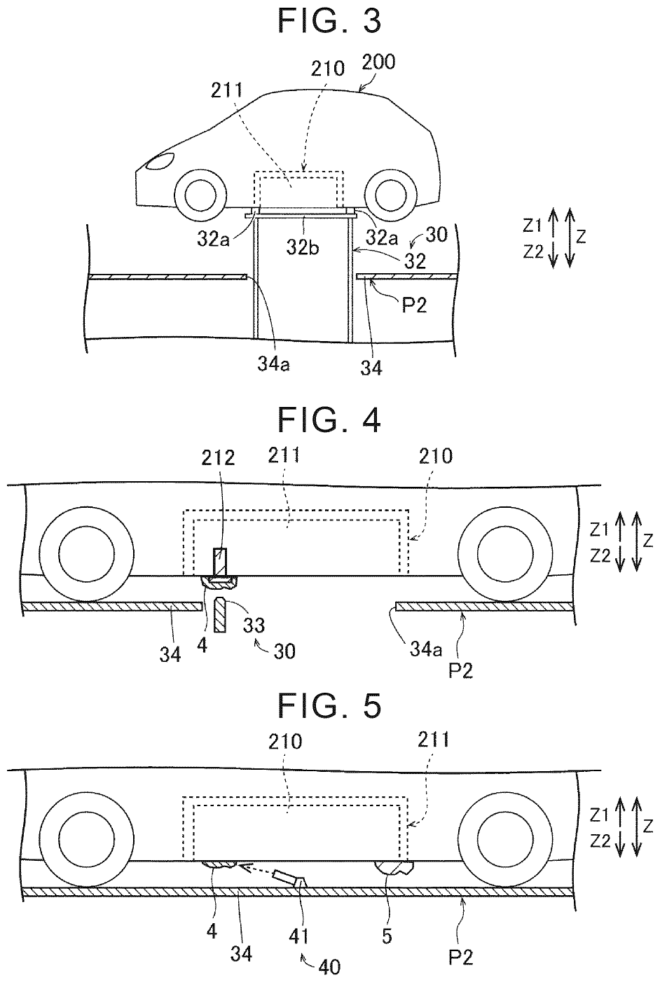

As illustrated in FIGS. 2 to 4, the inspection unit 30 includes a camera 31 (FIG. 2), a lift-up device 32 (FIG. 3), an inspection jig 33 (FIG. 4), and a vehicle arrangement unit 34. The camera 31 and the inspection jig 33 are examples of the “imaging unit” and the “jig” of the present disclosure, respectively.

As shown in FIG. 2, the camera 31 captures an image of the battery swap portion 210 (battery pack 211) from Z2. The cameras 31 are arranged so as to be positioned below an electrified vehicle 200 that is stopped in the vehicle arrangement unit 34 at the position P2. In FIG. 2, the camera 31 is provided so as to protrude from the vehicle arrangement unit 34, but the camera 31 may be buried in the vehicle arrangement unit 34. The image captured by the camera 31 is transmitted to the communication unit 13 (FIG. 1). The driving of the camera 31 is controlled by the processor 11 through the communication unit 13. The number of cameras 31 may be one, or may be two or more.

As shown in FIG. 3, the lift-up device 32 includes a plurality (e.g., four) of pressure-sensor 32a and a plurality (e.g., two) of lift-bar 32b. The plurality of lifting bar 32b lifts and lowers electrified vehicle 200 while supporting it from Z2. The lifting bar 32b can hold electrified vehicle 200 above the vehicle arrangement unit 34. Incidentally, the lifting and lowering of the lifting bar 32b is controlled by the processor 11 through the communication unit 13. In addition, the pressure sensor 32a is an exemplary “acquisition unit” of the present disclosure. The detected value of the pressure sensor 32a is one example of “information that is based on the tilt of the battery swap portion” of the present disclosure.

Each of the plurality of pressure-sensor 32a is disposed on an upper surface of the lifting bar 32b. Therefore, when 32b supports (holds) electrified vehicle 200, pressure from electrified vehicle 200 is applied to the pressure sensor 32a. The detected values of the respective pressure-sensor 32a are transmitted to the communication unit 13 (FIG. 1). The processor 11 may change the positional relation (distance) between the plurality of pressure-sensor 32a according to the type of electrified vehicle 200.

The lifting bar 32b moves between the lower portion of the vehicle arrangement unit 34 and the upper portion of the vehicle arrangement unit 34 through the opening/closing portion 34a provided in the vehicle arrangement unit 34. The opening/closing of the opening/closing portion 34a is controlled by the processor 11 through the communication unit 13.

As shown in FIG. 4, the inspection jig 33 is configured to be accessible to the battery swap portion 210. For example, the inspection jig 33 is configured to be movable to a position in contact with the bolt 212 provided in the battery swap portion 210. The movement of the inspection jig 33 is controlled by the processor 11 through the communication unit 13. The inspection jig 33 may be configured to be accessible to the battery swap portion 210 through the opening/closing portion 34a of the vehicle arrangement unit 34.

Here, there is a case where the inspection jig 33 cannot be moved to the position of the bolt 212 due to, for example, adhesion of the mud 4 to the bolt 212. The position information and the like of the inspection jig 33 are transmitted to the communication unit 13 (FIG. 1). Note that the information transmitted to the communication unit 13 is not limited to the positional information of the inspection jig 33.

FIG. 5 is a diagram illustrating an example of the cleaning unit 40. The cleaning unit 40 includes a water discharge unit 41. The water discharge unit 41 is disposed so as to be positioned below electrified vehicle 200 that is stopped by the vehicle arrangement unit 34 in the position P2. As a result, the water discharge unit 41 can discharge water from below to the battery swap portion 210. By discharging the water from the water discharge unit 41, the mud 4 adhering to the battery swap portion 210 can be removed, and the frozen portion 5 generated in the battery swap portion 210 can be removed. The water discharge direction and the like from the water discharge unit 41 are controlled by the processor 11 (FIG. 1) through the communication unit 13 (FIG. 1).

### Sequence Control of Battery Swap System

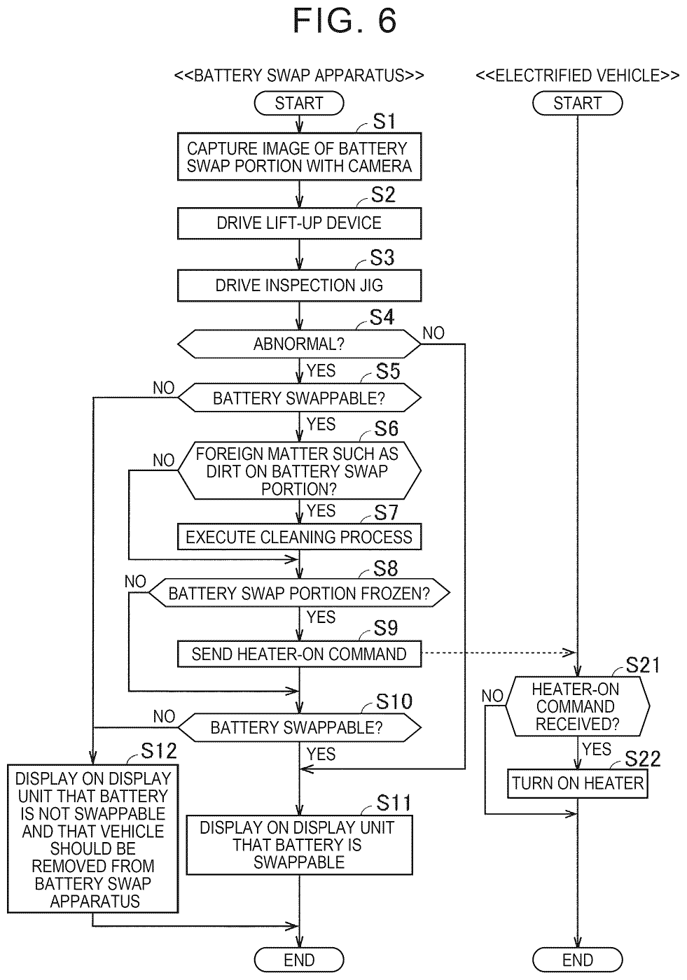

With reference to FIG. 6, the sequence control by the battery swap system 300 will be described. The control by the battery swap apparatus 100 is executed by the control unit 10 (the processor 11). In addition, the sequencing of FIG. 6 may be executed (started) every time electrified vehicle 200 stops in the position P2.

In S1, the battery swap apparatus 100 captures an image of the battery swap portion 210 of the electrified vehicle 200 by the camera 31 (FIG. 2). The communication unit 13 (FIG. 1) acquires an image captured by the camera 31.

In S2, the battery swap apparatus 100 drives the lift-up device 32 (FIG. 3) to hold electrified vehicle 200 by the lifting bar 32b. The communication unit 13 (FIG. 1) acquires information of values detected by the plurality of pressure-sensor 32a.

In S3, the battery swap apparatus 100 drives the inspection jig 33 (FIG. 4). The communication unit 13 (FIG. 1) acquires positional information and the like of the inspection jig 33. Note that the order of the processes from S1 to S3 is not limited to the above-described order.

In S4, the battery swap apparatus 100 determines whether or not there is an error in the battery swap portion 210 based on the data acquired from S1 in S3. Specifically, the battery swap apparatus 100 determines whether or not there is an abnormality in the battery swap portion 210. This determination is performed on the basis of the images of the cameras 31 acquired in S1, the information of the detected values of the plurality of pressure sensor 32a acquired in S2, the positional information of the inspection jig 33 acquired in S3, and the like. If there is an error in the battery swap portion 210 (Yes in S4), the process proceeds to S5. If there is no anomaly in the battery swap portion 210 (No in S4), the process proceeds to S12.

For example, the battery swap apparatus 100 identifies the presence (position, size, and the like) of the mud 4, the frozen portion 5, and the like (FIG. 5) based on the image acquired by the camera 31. In this determination, a learned model generated by a machine learning technique such as deep learning may be used.

The battery swap apparatus 100 calculates a tilt angle (e.g., an angle with respect to the horizontal direction) of electrified vehicle 200 (the battery swap portion 210) based on the detected values of each of the plurality of pressure-sensor 32a. For example, the battery swap apparatus 100 may calculate the tilt angle based on the deviation of the detection values of the pressure-sensor 32a. The battery swap apparatus 100 may detect the tilt by comparing the reference value indicating the detected value of each pressure sensor 32a when electrified vehicle 200 (the battery swap portion 210) is level with the detected value of each pressure sensor 32a. For example, the battery swap apparatus 100 may determine that there is an abnormality in the battery swap portion 210 when the calculated tilt angle is larger than a preset threshold A (for example, 5 degrees). The reference value and the threshold A may be stored in the memory 12 (FIG. 1). The reference value and the threshold A may be set for each vehicle type.

For example, when the height position of the inspection jig 33 in the Z direction is smaller than the threshold B, the battery swap apparatus 100 may determine that the movement of the inspection jig 33 cannot be normally performed due to the abnormality of the battery swap portion 210. The battery swap apparatus 100 may determine that there is an abnormality in the battery swap portion 210.

In S5, the battery swap apparatus 100 determines whether or not the battery swap process by the battery swap processing unit 20 (FIG. 1) can be executed. If the battery swap process is executable (Yes in S5), the process proceeds to S6. When the battery swap process is not executed (No in S5), the process proceeds to S12.

Specifically, the battery swap apparatus 100 may determine that the battery swap process is not possible when the tilt angle of the battery swap portion 210 calculated in S2 is larger than the threshold B. The threshold B may be a value larger than the threshold A. The thresholds B are stored in advance in the memory 12, and may be set for electrified vehicle 200 vehicle types.

Further, the battery swap apparatus 100 may determine that the battery swap process is not possible when the quantity of the foreign matter such as the mud 4 and the frozen portion 5 estimated based on the information acquired in each of S1 and S3 is larger than the threshold.

In S6, the battery swap apparatus 100 determines whether or not a foreign substance (FIG. 5) such as mud 4 is attached to the battery swap portion 210. If foreign matter such as mud 4 is attached (Yes in S6), the process proceeds to S7. If no foreign matter such as mud 4 is attached (No in S6), the process proceeds to S8.

In S7, the battery swap apparatus 100 executes a cleaning process. Specifically, the battery swap apparatus 100 drives the water discharge unit 41 (FIG. 5) to remove foreign matters such as the mud 4 adhering to the battery swap portion 210. The water discharge by the water discharge unit 41 is an example of the “abnormality elimination process” of the present disclosure. Therefore, the water discharge unit 41 is an example of the “abnormality elimination unit” of the present disclosure. The process then proceeds to S8.

In S8, it is determined whether or not the frozen portion 5 (FIG. 5) has occurred in the battery swap portion 210. If the frozen portion 5 has occurred (Yes in S8), the process proceeds to S9. If the frozen portion 5 has not occurred (No in S8), the process proceeds to S10.

In S9, the battery swap apparatus 100 transmits a command signal for turning ON the heater 240 (FIG. 1) to electrified vehicle 200 through the communication unit 13 (FIG. 1). Note that transmitting the command signal is an example of the “abnormality elimination process” of the present disclosure. Therefore, the communication unit 13 is an example of the “abnormality elimination unit” of the present disclosure. The process then proceeds to S10.

In S10, the battery swap apparatus 100 checks S3 again from S1, and then determines whether or not the battery swap process can be executed in the same manner as in S5. If the battery swap process is executable (Yes in S10), the process proceeds to S11. If the battery swap process is not executed (No in S10), the process proceeds to S12.

Note that only one of the processing for determining whether or not to execute the battery swap process in S10 and the processing for determining whether or not to execute the battery swap process in S5 may be executed.

In S11, the battery swap apparatus 100 causes the display unit 50 to display that the battery swap process can be executed through the communication unit 13 (FIG. 1). For example, the battery swap apparatus 100 displays a message “Please proceed to the battery swap process because the battery swap process can be executed” on the display unit 50. Thereafter, the process of the battery swap apparatus 100 ends. Note that the position P2 may be provided with a stopper (not shown) for restricting the movement of electrified vehicle 200 to the position P1 until the battery swap process of another electrified vehicle is completed.

In S12, the battery swap apparatus 100 sends a notification to prompt to remove the electrified vehicle 200 from the battery swap apparatus 100 (position P1) through the communication unit 13 (FIG. 1). For example, the battery swap apparatus 100 displays a message “Please remove the electrified vehicle from the battery swap apparatus because the battery swap process is not executable” on the display unit 50. Thereafter, the process of the battery swap apparatus 100 ends.

In S21, electrified vehicle 200 determines whether or not a command to turn ON the heater 240 (S9 command) has been received. If a command to turn ON the heater 240 has been received (Yes in S21), the process proceeds to S22. If a command to turn ON the heater 240 has not been received (Yes in S21), electrified vehicle 200 process ends.

In S22, electrified vehicle 200 performs control to turn ON the heater 240. As a result, the temperature of the battery pack 211 (the battery swap portion 210) is increased. Thereafter, electrified vehicle 200 process ends.

As described above, in the present embodiment, the position P1 at which the battery swap process is executed by the battery swap processing unit 20 differs from the position P2 at which the inspection by the inspection unit 30 is executed. Thus, the electrified vehicle 200 can be removed from the battery swap apparatus 100 before the electrified vehicle 200 on which the battery swap process is not executable is moved to the battery swap position (position P1). As a result, it is possible to reduce a traffic congestion due to the electrified vehicle 200 waiting for the battery swap process. As a result, it is possible to reduce the waiting time of the electrified vehicle 200 in the battery swap apparatus 100. Modifications

In the above embodiment, the user of electrified vehicle 200 is notified of whether or not the battery swap process can be executed. For example, only the presence or absence of an abnormality in the battery swap portion 210 may be notified to the user.

In the above-described embodiment, an example has been described in which, when there is an abnormality in the battery swap portion 210, a process for eliminating the abnormality (water discharge by the water discharge unit 41) is executed, but the present disclosure is not limited to this. When there is an abnormality in the battery swap portion 210, the process of eliminating the abnormality may not be executed. That is, the battery swap apparatus 100 does not have to be provided with a device (water discharge unit 41) for eliminating the abnormality.

In the above-described embodiment, the process (water discharge by the water discharge unit 41) for eliminating the anomaly of the battery swap portion 210 is executed in the position P2 in which the inspection by the inspection unit 30 is executed. The process for resolving the anomaly may be executed, for example, in a position P1 or between the position P1 and the position P2 in which the battery swap process is executed.

In the above-described embodiment, an inspection using the camera 31, an inspection using the lift-up device 32, and an inspection using the inspection jig 33 are executed, but the present disclosure is not limited thereto. Only one or two of the three inspections may be executed.

In the above embodiment, the process of turning ON the heater 240 when the frozen portion 5 is generated in the battery swap portion 210 is executed, but the present disclosure is not limited to this. For example, the frozen portion 5 may be removed by discharging water to the frozen portion 5 by the water discharge unit 41. The temperature of the water discharged to the frozen portion 5 may be higher than the temperature of the water discharged to the foreign matter such as the mud 4.

In the above-described embodiment, an example in which the presence of a foreign substance or the like is detected based on the positional information or the like of the inspection jig 33 has been described, but the present disclosure is not limited thereto. For example, a sensor (temperature sensor, humidity sensor, and a pressure sensor or the like) to the inspection jig 33 is provided, it may detect the presence of foreign matter based on the detected value of the sensor.

In the above-described embodiment, the message (51, 52) for notifying whether or not the battery swap process can be executed is displayed on the display unit 50 provided in the battery swap apparatus 100, but the present disclosure is not limited thereto. For example, the notification may be made by voice. The notification may be displayed on electrified vehicle 200 navigational device 220, a user terminal owned by a user of electrified vehicle 200, or the like. Examples of the user terminal include a smart phone and a PC.

In the above embodiment, an example in which each of the battery swap processing unit 20, the inspection unit 30, the cleaning unit 40, and the display unit 50 is controlled by the processor 11 has been described, but the present disclosure is not limited thereto. For example, each of the battery swap processing unit 20, the inspection unit 30, the cleaning unit 40, and the display unit 50 may be controlled by a different processor. In addition, two or three of the battery swap processing unit 20, the inspection unit 30, the cleaning unit 40, and the display unit 50 may be controlled by the same processor.

In the above-described embodiment, an example has been described in which water is discharged by the water discharge unit 41 when the mud 4, the frozen portion 5, and the like are present in the battery swap portion 210, but the present disclosure is not limited thereto. For example, when the mud 4, the frozen portion 5, and the like are present in the battery swap portion 210, the worker of the battery swap apparatus 100 may be notified of the cleaning command of the battery swap portion 210.

In the above embodiment, electrified vehicle 200 heater 240 are turned ON when the frozen portion 5 is present in the battery swap portion 210, but the present disclosure is not limited thereto. For example, the battery swap apparatus may turn ON heater provided in the position P2 (such as the vehicle arrangement unit 34) when the frozen portion 5 is present in the battery swap portion 210.

In the above embodiment, the abnormal state of the battery swap portion 210 is inspected by using the camera 31 of the battery swap apparatus 100 provided in the position P2. An anomaly in the battery swap portion 210 may be inspected using a camera provided in electrified vehicle. Thus, the presence or absence of an anomaly in the battery swap portion 210 can be inspected earlier (prior to electrified vehicle 200 arriving at the position P2). Here, a command for operating the camera may be transmitted from the battery swap apparatus to electrified vehicle.

In the above-described embodiment, an example in which whether or not to execute the battery swap process is determined by the tilt of the battery swap portion 210 has been described, but the present disclosure is not limited to this. For example, the position and weight (size) of the foreign matter, the frozen portion 5, and the like adhering to the battery swap portion 210 may be detected by the tilt of the battery swap portion 210.

In the above-described embodiment, an example in which the inspection of the battery swap portion 210 is executed outside the battery swap apparatus body 1 has been described, but the present disclosure is not limited thereto. Inspection of the battery swap portion 210 may be executed inside the battery swap apparatus body 1.

In the above embodiment, the tilt angle of the battery swap portion 210 is calculated based on the detected values of the plurality of pressure-sensor 32a. For example, the tilt angle of the battery swap portion 210 may be calculated based on the image acquired by the camera 31.

In the above-described embodiment, an example in which foreign matter or the like is removed by water discharge by the water discharge unit 41 has been described, but the present disclosure is not limited to this. For example, a foreign substance or the like may be removed by a jig (tool) or the like that applies an external force to the foreign substance or the like.

The configuration of the battery swap apparatus 100 shown in the above embodiment is merely an example, and the configuration of the battery swap apparatus 100 described in the above embodiment may be appropriately changed within an appropriate range in the present disclosure.

Note that the configurations (processes) of the above-described embodiments and the above-described modification examples may be combined with each other.

The embodiment disclosed herein shall be construed as exemplary and not restrictive in all respects. The scope of the present disclosure is shown by the claims rather than by the above description of the embodiments, and is intended to include all modifications within the meaning and scope equivalent to those of the claims.

What is claimed is:

1. A battery swap apparatus that executes a battery swap process for swapping out a battery mounted on an electrified vehicle, the battery swap apparatus comprising:
a battery swap processing unit configured to execute the battery swap process; and
an inspection unit configured to inspect a state of a battery swap portion of the electrified vehicle before the battery swap process, the battery swap portion being a portion related to the battery swap process, wherein a first position where the battery swap process is executed by the battery swap processing unit is different from a second position where inspection is executed by the inspection unit.

2. The battery swap apparatus according to claim 1, further comprising:
a swappability determination unit configured to determine whether the battery swap process is executable, based on a result of the inspection by the inspection unit; and
a notification unit configured to execute a notification process for notifying a user of the electrified vehicle of information, wherein when the swappability determination unit determines that the battery swap process is not executable, the notification unit executes the notification process for notifying the user that the battery swap process is not executable, before the electrified vehicle is moved to the first position.

3. The battery swap apparatus according to claim 1, further comprising:
an abnormality determination unit configured to determine whether there is an abnormality in the battery swap portion, based on a result of the inspection by the inspection unit; and
an abnormality elimination unit configured to execute an abnormality elimination process for eliminating the abnormality in the battery swap portion, wherein the abnormality elimination unit executes the abnormality elimination process when the abnormality determination unit determines that there is the abnormality in the battery swap portion.

4. The battery swap apparatus according to claim 1, wherein the inspection unit inspects the electrified vehicle at the second position while the battery swap process is being executed on another electrified vehicle at the first position.

5. The battery swap apparatus according to claim 1, wherein the inspection unit includes at least one of the following: an imaging unit configured to capture an image of the battery swap portion, a jig that is accessible to the battery swap portion, and an acquisition unit configured to acquire information that is based on a tilt of the battery swap portion.
